(19) United States
(12) Patent Application Publication
(10) Pub. No.: US 2026/0192350 A1
(43) Pub. Date: Jul. 9, 2026

(54) Plant for Forming a Polar Plate of a Fuel Cell, and Associated Forming Method

(71) Applicant: SYMBIO FRANCE, Saint-Fons (FR)

(72) Inventors: Pascal Paul Jendrzejczak, Bizeneuille (FR); Marcel Jacques Becker, Besancon (FR)

(21) Appl. No.: 18/863,860

(22) PCT Filed: May 5, 2023
(86) PCT No.: PCT/EP2023/062023

§ 371 Date: Nov. 7, 2024

(30) Foreign Application Priority Data
May 9, 2022 (FR) 2204376

(51) Int. Cl. B21D 35/00; B21C 51/00; B21D 28/04; B21D 37/08; B21D 43/02; H01M 4/86; H01M 4/88

(52) U.S. Cl. CPC B21D 35/001; B21C 51/005; B21D 28/04; B21D 37/08; B21D 43/021; H01M 4/8875; H01M 4/8896; H01M 2004/8694

(57) ABSTRACT

A forming plant configured to form polar plates in series from a strip, wherein the plant comprises the following three presses, wherein each such press comprising an actuator that moves a slider in a vertical reciprocating motion
an upstream press;
an intermediate press comprising a stamping tool configured to stamp a network of circulation channels on the strip; and
a downstream press;
   wherein:
the strip runs continuously through the three presses;
the forming plant comprises tensioning members configured to keep portions of the strip in the presses tensioned, while keeping released portions of the strip in between the presses;
the actuator of the intermediate press exerts on the stamping tool a pressing force which passes through a connection point between the slider and the said actuator and which passes through the network of circulation channels on the strip.

The present invention relates to an installation for forming a polar plate for a bipolar separator of a fuel cell, as well as to a forming method implemented by means of such a forming plant.

A fuel cell is a device for generating electricity by electrochemical reaction between a fuel, e.g. hydrogen, and an oxidizer, e.g. oxygen contained in the air. We are interested herein in solid electrolyte proton exchange membrane type fuel cells—also called PEMFC—which usually comprise a stack of elementary cells each forming an electrochemical generator.

Schematically, each cell comprises two polar plates, between which are arranged a cathode element and an anode element, which are separated by a solid electrolyte in the form of an ion exchange membrane, made e.g. of a sulfurized perfluoropolymer material. Each polar plate comprises a front face, with a central portion wherein hydrogen and oxygen circulation channels are provided, and a rear, opposite the front face. In a cell, the front face of each polar plate is oriented towards the membrane.

For two neighboring cells, a polar plate of one of the two cells ends up back-to-back with a polar plate of the other cell. The two polar plates together form a bipolar separator, also called a bipolar plate. A cooling circuit, wherein circulates a cooling liquid such as glycol-containing water, is generally arranged between the two polar plates of the bipolar separator. Hydrogen, air and coolant are fluids that are continuously supplied to the fuel cell during the operation thereof. Openings are provided in each polar plate around the central portion to allow fluids to pass between two adjacent cells. Thereby, each bipolar separator supplies to the cell adjacent on one side fuel to said side and on the other side supplies oxidizer to the cell adjacent to said other side, the supplies provided by the bipolar separators taking place in parallel.

We are interested herein in metal polar plates, which are made of sheet metal. The openings are generally formed by perforation, whereas the channels are made by stamping. For the fuel cell to work properly, the polar plates have very fine thicknesses and very narrow manufacturing tolerances. As an order of magnitude, a polar plate is conventionally made of a 0.1 mm thick sheet, whereas the channels each have a depth of 0.2 mm to 0.3 mm, with a tolerance of less than 0.01 mm.

To reduce production costs, polar plates are manufactured in series, from a strip wound in the form of a coil, the strip being perforated and stamped and finally cut out to form each polar plate.

It is known to carry out the three operations, possibly subdivided into sub-steps, with a large-capacity press comprising a plurality of tools, which together form the tool set of the press. Such a press generally comprises a frame, a slider, which is movable with respect to the frame, and a working zone, called a table, which is stationary with respect to the frame and which is arranged opposite the slider. The tools are distributed along the table. Between each press operation, the strip is advanced by a fixed pitch along the table, so as to shape the strip gradually. As orders of magnitude, a polar plate has e.g. a width of 180 mm, whereas the table has a length comprised between 1500 mm and 2000 mm, eight to ten tools typically being distributed along the table.

In order to ensure each of the operations satisfactorily, the press is generally dimensioned to ensure a sufficient force for each operation. Typically, a press is sized to generate a force on the order of 800 tons or even more. However, such forces lead to deformations of the frame and of the table, the deformations reaching up to 0.04 mm in the center of the table during stamping operations, which is unacceptable given the tolerances required for the manufacture of the channels.

U.S. Pat. No. 9,821,360 describes e.g. a forming plant comprising three presses, which operate in parallel to carry out the perforation, stamping and cutting operations. The strip is rolled up after passing through each of the presses and then unrolled before passing through the next press, which may damage the channels and reduces the productivity of the forming plant.

JP-4 464934-B2 and US-2015/280252-A1 each describe other examples of polar plate forming plants wherein the strip is wound between the forming steps. US-2018/223408-A1 describes an installation for forming fins for a vehicle radiator.

It is such problems that the invention more particularly seeks to remedy, by proposing a forming plant that provides good productivity while making possible the production of parts with low geometric tolerances.

To this end, the invention relates to a polar plate forming plant for electrochemical cells of a fuel cell, wherein:
the forming plant is configured to form the polar plates in series from a metal strip, each polar plate being made as an elementary section of the strip,
the forming plant comprises three separate presses, each comprising:
   a movable slider arranged opposite a stationary table, the slider being moved by an actuation device between an upper position and a lower position, the slider and the table together delimiting a working volume of the press,
   a shaping tool set for forming the strip, each shaping tool set comprising at least one tool with a movable portion, which is carried by the corresponding slider and which delimits a working zone of the corresponding press,
each press is configured to let through the strip into the corresponding working volume and includes a feeding device for moving the strip, configured to control a feeding movement of the strip along the table, the feeding movement being a sequential movement, with an increment of the feeding equal to a length of each elementary section measured along the strip, and a predetermined feeding frequency, the feeding movement defining a downstream direction of each press, each press being configured to move the corresponding slider to a lower position after each feeding movement,
the presses include:
   an upstream press, the tool set of which includes a primary marking tool, which is configured to form a primary reference mark on the strip when the corresponding slider moves from the upper position thereof to the lower position thereof,
   an intermediate press, the tool set of which includes a stamping tool, which is fastened to the corresponding slider and which is configured to stamp in relief, a network of channels for the circulation of fluids on the strip, when the corresponding slider moves from the upper position thereof to the lower position thereof,
   a downstream press, the tool set of which includes a cutting tool, configured to separate each elementary section from the rest of the strip, when the corresponding slider moves from the upper position thereof to the lower position thereof.

According to the invention:
the intermediate press is arranged, in the feeding direction, downstream of the upstream press, while the downstream press is arranged downstream of the intermediate press, in such a way that, under established operation of the forming plant, the strip runs continuously through the three presses, each portion of the strip received in the working volume of one press being an internal portion of the strip, whereas each portion of the strip situated between two adjacent presses is an external portion of the strip,
the forming plant comprises tensioning members, which are arranged between two adjacent presses and which are configured to keep the inner portions of the strip taut, while keeping the outer portions of the strip released,
the actuation device for the intermediate press comprises a pressing actuator, which is connected to the slider by a connection point and which moves the slider between the upper and lower positions thereof and which is configured to exert a pressing force on the slider when the corresponding slider is in the lower position thereof and the strip is stamped by the stamping tool, and
the pressing force is oriented along a pressing axis, which runs through the connection point and which runs through the network of channels.

Due to the invention, the intermediate press is intended for the stamping step and optimized for such purpose, with a pressing actuator arranged vertically with respect to the stamping tool, so as to distribute the deformations of the intermediate press around the zone of channels stamped on the strip, reducing the dimensional dispersion of the channels thereby formed. On the other hand, by means of the tensioning members, the strip is released between the presses, which prevents the transmission from one press to another, by the strip, of mechanical forces generated during shaping. More particularly, the stamping step tends to pull on the strip. The forming plant thereby makes possible a continuous production of polar plates, with low geometric tolerances.

According to advantageous but non-mandatory aspects of the invention, such a forming plant can incorporate one or a plurality of the following features, taken individually or according to any technically permissible combination:
The stamping tool is configured to stamp the network of channels of only one elementary section on the strip, after each feeding movement.
The tool set of the intermediate press does not include any other strip shaping tool than the stamping tool.
The tool set of the intermediate press includes, in addition to the stamping tool, a secondary marking tool configured to form a secondary marking on the strip while the strip is held clamped in the stamping tool.
The secondary marking tool is configured to form the secondary reference mark on the strip when the slider of the intermediate press is in the lower position or close to the lower position thereof.
The feeding device of the downstream press comprises positioning members, which are configured to cooperate with the secondary reference mark formed on the strip, so as to position the strip in the downstream press.
The actuation device of the intermediate press comprises a servomotor, which controls the pressing actuator and which is configured to maintain a pressing force for a predetermined time when the slider is in the lower position, whereas the secondary marking tool comprises another actuation device, which is carried by the slider and which is triggered while the strip is held clamped in the stamping tool, so as to form the secondary reference mark on the strip.
The actuation device of the intermediate press consists of only one pressing actuator.
The actuation device of the intermediate press is configured to generate a nominal pressing force of less than 4 Mega Newtons, preferably less than 3 Mega Newtons, else preferably less than 2 Mega Newtons.
The intermediate press table is a solid table.

According to another aspect, the invention relates to a method of forming a polar plate, the forming method being implemented by means of a forming plant as defined hereinabove, the forming method comprising the steps consisting of:
a) while an inner portion of the strip is received in the working volume of the intermediate press, moving the slider from the upper position thereof to the lower position thereof, and stamping on the strip the relief of the network of channels for the circulation of fluids,
b) while the strip is held clamped in the stamping tool, using the secondary marking tool and form the secondary reference mark on the strip.

Such method leads to the same advantages as the advantages mentioned hereinabove with regard to the forming plant of the invention.

The invention will be better understood and other advantages thereof will appear more clearly in the light of the following description of an embodiment of a forming plant and of a forming method according to the principle thereof, given only as an example and made with reference to the enclosed stampings, wherein:

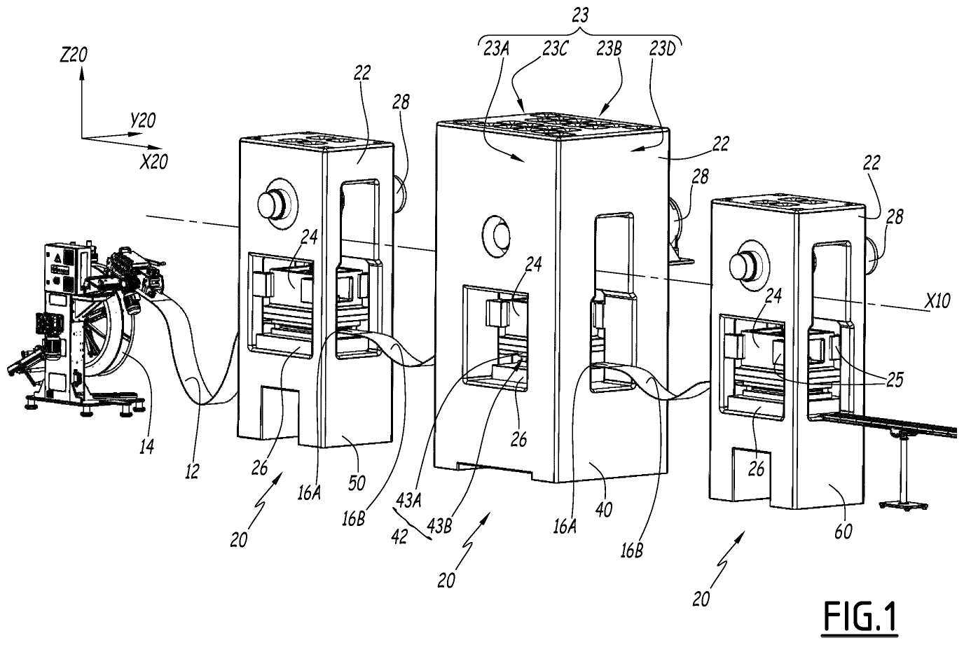

FIG. 1 is a perspective view of a forming plant for polar plates;

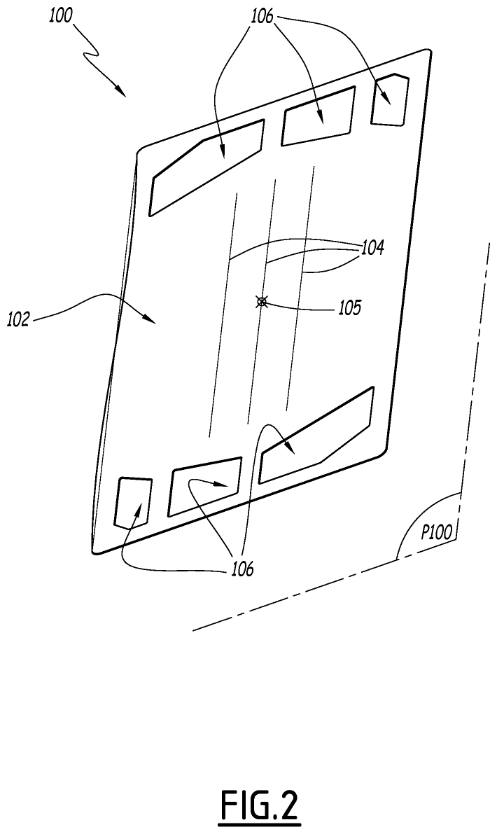

FIG. 2 is a schematic representation of a perspective view of a polar plate;

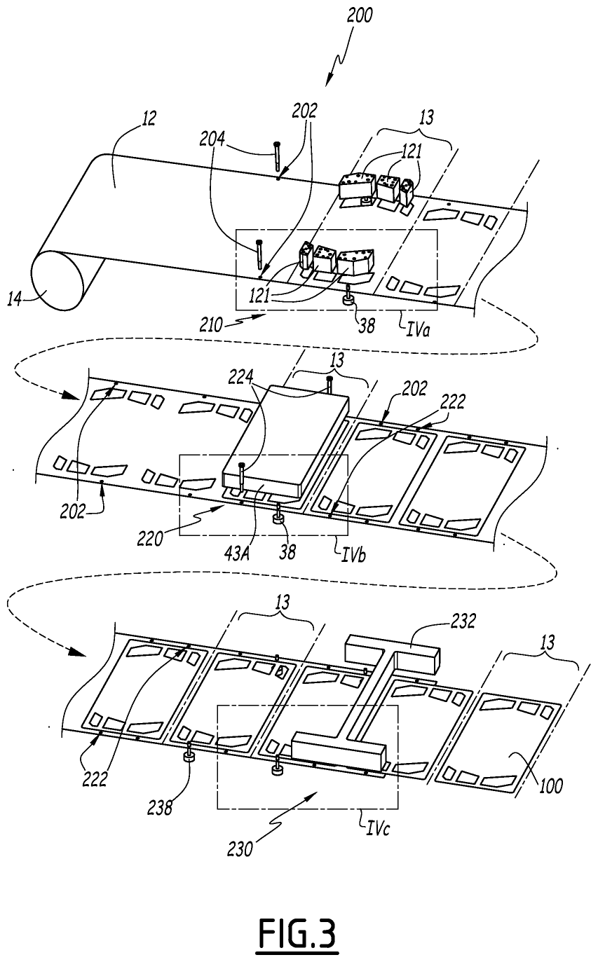

FIG. 3 is a schematic representation of an embodiment of the forming method implemented with the forming plant shown in FIG. 1;

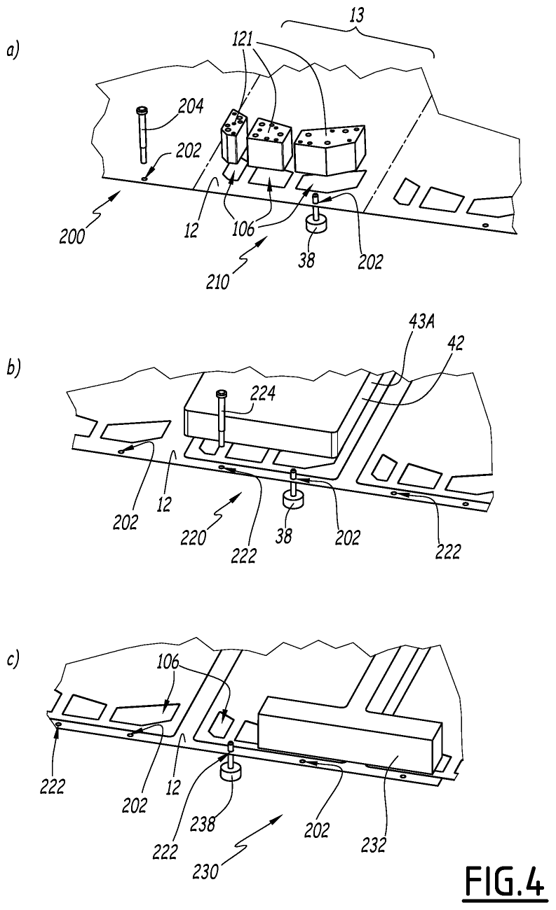

FIG. 4 shows on a larger scale, on three inserts a) to c), frames IVa, IVb and IVc in FIG. 3, and

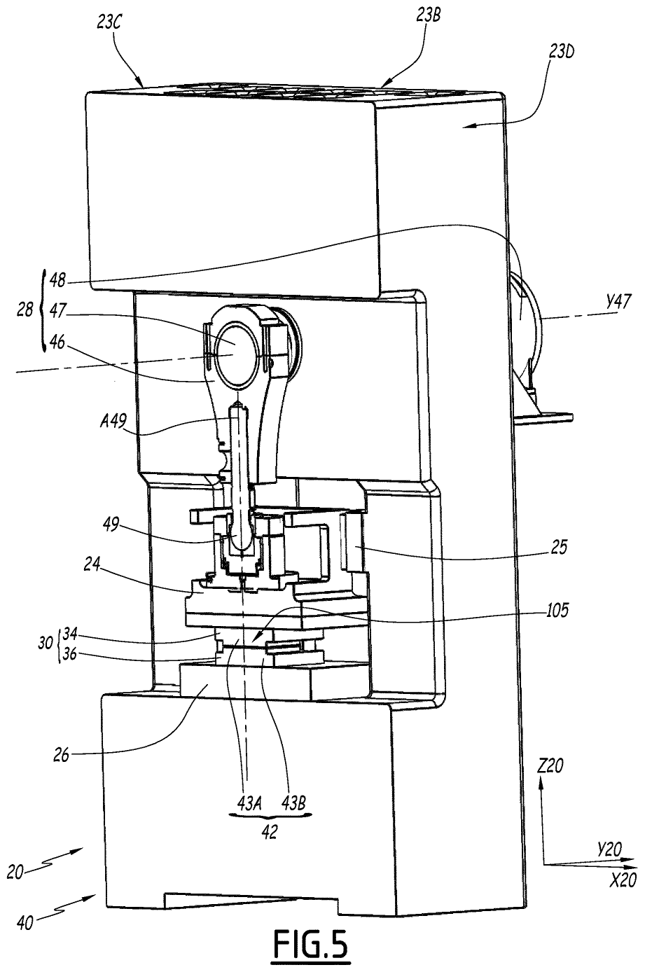

FIG. 5 is a schematic perspective representation of the forming plant shown in FIG. 1.

A forming plant 10 is shown in FIG. 1. The forming plant 10 is configured to form polar plates for electrochemical cells of a fuel cell. A polar plate 100 is shown in FIG. 2.

The polar plate 100 is made of a metal sheet, e.g. of stainless steel. Each polar plate 100 has an overall rectangular shape which extends along a plate plane P 100. The polar plate 100 comprises a central portion 102 wherein is provided a network of channels 104 for the circulation of a fluid needed for the operation of the fuel cell. The fluid is e.g. one amongst hydrogen, air, and glycol water. The network of channels 104 is represented schematically by three lines. A center 105 of the channel network 104 is defined as being a geometric center of gravity of the channel network 104. In the example illustrated, the polar plate 100 has the shape of a rectangle, while the center 105 is situated schematically at the intersection of the diagonals of the rectangle.

The polar plate 100 also comprises perforations 106, which are formed at the periphery of the central portion 102 and which are provided for the passage of fluids from one side of the polar plate 100 to the other. In the example illustrated, the perforations 106 are divided into two groups of three perforations, the shape and arrangement of the perforations 106 not being limiting.

The forming plant 10 is configured to form the polar plates 100 in series, from a strip 12. The strip 12 is a metal strip, which is generally transported rolled up in the form of a roll 14. The roll 14 is unrolled at the inlet of the forming plant 10, the strip 12 being shaped in the forming plant 10, i.e. shaped and cut in the presses of the forming plant 10, in order to form the polar plates 100. Each polar plate 100 is thereby provided in an elementary section 13 of the strip 12 and corresponds, apart from the material losses and losses generated during shaping, to an elementary section 13 of the strip 12.

The forming plant 10 comprises three distinct presses 20. Each press 20 comprises a frame 22, which overall has the shape of an elongated parallelepiped, which extends along a height axis Z20. When the press 20 is in the operating configuration, the frame 22 is placed on the ground, the height axis Z20 being orthogonal to the ground. The ground is assumed to be horizontal, so the axis height Z20 is assumed to be vertical. The frame 22 comprises four peripheral faces 12, among which a front face 23A, a rear face 23B opposite the front face 23A, an upstream face 23C and a downstream face 23D opposite the upstream face 23C and orthogonal to the front face 23A and the rear face 23B. In FIGS. 1 and 5, the presses 20 are shown in perspective, the front face 23A of each press being oriented towards the left of the figures, whereas the downstream face 23D is oriented towards the right.

For each press 20, the front 23A and rear 23B faces are orthogonal to an axis of depth Y20 of the press, whereas the upstream 23C and downstream 23D faces are orthogonal to a transverse axis X20 of the press, the three axes, the transverse axis X20, the depth axis Y20 and the height axis Z20 being oriented to form a direct coordinate system.

Each press 20 comprises a slider 24 which is movable with respect to the frame 22, the slider 24 being guided in translation with respect to the frame 22 along the height axis Z20, herein by means of sliders 25 which are visible in FIG. 5. Each press 20 further comprises a table 26 which is stationary with respect to the frame 22 and which is arranged facing the corresponding slider 24, the slider 24 and the table 26 together delimiting a working volume V20 of the press 20. In the operating configuration of the press 20, the table 26 is located under the slider 24.

Each press 20 further comprises an actuation device 28 which moves the slider 24 between the lower and upper positions thereof. The slider 24 is closer to the table 26 in the lower position than in the upper position. By extension, each press 20 is in a lower configuration or in an upper configuration respectively, when the corresponding slider 24 is in the lower position thereof, or in the upper position respectively thereof. Each press 20 moves from the upper configuration thereof to the lower configuration thereof when same is called triggered, and then returns to the upper configuration thereof at the end of a predetermined time interval.

Each press 20 is equipped with a tool 30 for shaping the strip 12. As illustrated in FIGS. 3 and 4, the shaping of the strip 12 takes place in a plurality of successive steps, each of the steps being carried out using a specific tool mounted on one of the presses 20. All the shaping tools mounted on the same press 20 form a tool set 30 of the press 20. The tool set 30 of each press 20 thus comprises, as the case may be, one or a plurality of shaping tools. “Shaping” refers to an operation that deforms the strip, e.g. a plastic deformation, cutting, drilling, etc. A simple elastic deformation, an inspection or a cleaning operation are thus not considered to be shaping.

The three presses 20 are aligned with respect to one another, more precisely the transverse axes X20 of the three presses 30 are aligned, the one of the three presses 20 which is situated between the other two presses being called the “intermediate press 40”. The one press amongst the presses 20 arranged facing the upstream face 23C of the intermediate press 40 is called the “upstream press 50”, whereas the third press 20, which is arranged facing the downstream face 23D of the intermediate press 40, is called the “downstream press 60”.

In FIG. 5, the intermediate press 40 is shown in section along a plane orthogonal to the depth axis Y20, revealing the inside of the intermediate press 40. For each press 20, each tool—and by extension each tool set 30—of the press comprises a movable portion 34, which is carried by the corresponding slider 24, and a fixed portion 36, fastened opposite the movable portion 32 on the corresponding table 26. Each movable portion 34 delimits, with the associated stationary portion 36, a working zone of the corresponding press 20, each working zone being configured to receive an elementary section 13 of the strip 12.

The steps of the method for forming the strip 12 are now described in detail. FIG. 3 shows, at the input to the forming method, a roll 14 which is unwound, the strip 12 being fed-in progressively, the feeding of the strip 12 being shown from left to right and from top to bottom.

During a first step 200 called “primary marking”, a primary reference mark 202 is formed on the strip 12 by means of a primary marking tool 204 belonging to the forming plant 10. The primary marking tool 204 herein comprises two perforating punches, whereas the primary marking 202 herein is formed of two holes, each arranged along a respective edge of the strip. According to an alternative (not shown), the primary marker 204 is obtained by plastic deformation of the strip 12, e.g. by punching. However, the primary reference mark 202 is preferably formed by one or a plurality of holes.

The primary marking tool 204 is herein mounted on the slider 24 of the upstream press 50. The primary reference mark 202 is thereby formed on the strip 12 each time the slider 24 of the upstream press 50 passes from the upper position thereof to the lower position thereof, in other words each time the upstream press 50 is activated and moves from the upper configuration thereof to the lower configuration thereof. Thereby, preferably, a primary reference mark 202 is formed for each elementary section 13 of the strip 12.

Between each triggering of the upstream press 50, once the upstream press 50 has returned to the upper configuration thereof, the strip 12 is moved relative to the upstream press 50 according to a feeding movement of the strip 12 along the table 26, parallel to the axis X20. The feeding movement of the strip 12 is a sequential movement, with a feeding increment equal to a length of each elementary section 13 measured along the strip 12, parallel to the axis X20, and a predetermined feeding frequency. The feeding movement of the strip 12 defines an upstream-downstream direction of the forming plant 10. Generally, the feeding frequency is equal to the triggered frequency of the press.

The upstream press 50, and more generally each press 20, comprises a feeding device for the strip 12, configured to control a feeding movement of the strip 12 along the corresponding table 26. The feeding device is not shown. The feeding movement of the strip 12 is preferably synchronized for each press 20, each press 20 being configured to move the corresponding slider 24 to the lower position after each feeding movement.

The upstream press 50 further comprises positioning members 38, which are configured to cooperate with the primary reference mark 202 provided in the strip 12 so as to position the strip 12 with respect to the upstream press 50, after each feeding movement of the strip 12. The positioning members 38 are herein formed by positioning fingers which are inserted into the holes of the primary reference marks 202. The positioning fingers are preferably conical. A precise and repeatable positioning of the strip 12 with respect to the tools 30 of the upstream press 50 is thereby obtained. The positioning members 38 can be movable, in particular along the direction of the axis Z20, with an alternating movement having the same frequency as the triggered frequency of the press.

Then, after the primary marking step 200, during a step 210 called perforation step, the perforations 106 are formed through the strip 12, by means of a perforation tool 121. The perforation step 210 is thus a shaping step. The perforating tool 121 herein comprises six punches, each of which is configured to form a respective perforation 106. The punches are mounted on the slider 24 of the upstream press 50 and are configured to cooperate with a die fastened to the table 26 of the upstream press 26. The die is not shown.

During the perforation step 210, the positioning members 38 thereby serve for a good alignment of the strip 12 with respect to the punches used to form the perforations 106, and by extension with respect to the perforation tool 121.

The primary marking step 200 and the perforation step 210 are e.g. two steps each corresponding to a distinct triggering of the upstream press 50. The primary marking step 200 and the perforation step 210 are e.g. two steps each corresponding to one of two immediately successive distinct triggerings of the upstream press 50.

Then, after the perforation step 210, during a so-called stamping step 220, the strip 12 is stamped, in other words the strip 12 is plastically deformed, so as to imprint thereon the network of fluid circulation channels 104 in relief, by means of a stamping tool fastened to the slider 24 of the corresponding press. The stamping step 220 is thus a shaping step. Typically, the stamping tool comprises two dies of mating shape, which are positioned on both sides of the part to be stamped, herein the strip 12. The stamping step 220 is implemented here by the intermediate press 40, which is thus a stamping press, the tools 30 of which include a stamping tool 42, which comprises a movable die 43A which is fastened to the slider 24 by a fastening device, and a mating die 43B supported by the table 26. The fastening device is not shown. Conventionally, the fastening device provides a support zone between the movable die 43A and the slider 24, the support zone being flat.

During the stamping step 220, the strip 12 tends to deform, so the primary reference mark 202, formed on the strip 12, moves with respect to the original position thereof on the strip 12 and can no longer fulfill the reference role thereof. To overcome such problem, during the stamping step 220, once the network of channels 104 is formed by stamping on the strip 12, while the strip 12 is held clamped in the stamping tool 42, which corresponds to the fact that the corresponding slider 24 is in the lower position or close to the lower position thereof, a so-called secondary reference mark 222 is formed on the strip, by means of a secondary marking tool 224 carried by the slider 24. In the example illustrated, the secondary marking tool 224 comprises two perforation punches, whereas the secondary reference mark 222 is formed of two holes, each arranged along a respective edge of the strip 12. In general, the secondary reference mark 222 is preferably formed by one or a plurality of holes in the strip 12. Preferably, a secondary reference mark 222 is formed for each elementary section 13 of the strip 12

The secondary marking tool 224 comprises another actuation device, called secondary actuation device, which is carried by the corresponding slider 24 and which moves the perforation punches while the strip is held clamped in the stamping tool 42, so as to form the secondary reference mark 222 on the strip 12. The secondary actuation device is not shown. Thereby, the secondary marking tool 224 is placed in a working position when the slider 24 is in the lower position or close to the lower position thereof, when the strip 12 is held clamped in the stamping tool 42, the secondary actuation device then being activated to form the secondary reference mark 222. The secondary reference mark 222 can thereby be formed on the strip 12 at the moment chosen by the operator, as long as the strip 12 is held clamped in the stamping tool 42.

The actuation device 28 of the intermediate press 40 comprises a pressing actuator 46 which moves the corresponding slider 24 between the upper and lower positions thereof and which is configured to exert a pressing force on the slider 24 when the slider 24 is in the lower position thereof and the strip 12 is pressed by the pressing tool 42. The pressing actuator 46 herein includes a connecting rod, which is mounted by an upper end on an eccentric crank shaft 47 pivoting eccentrically about an axis parallel to the depth axis Y20. The pressing actuator 46 is connected to the slider 24 by a connection point 49. In the example, the pressing actuator 46 includes a connecting rod which is connected, at the lower end thereof, to the slider 24 by a pivot or ball joint connection forming the connection point 49 through which the pressing force passes. The actuation device 28 further comprises a servomotor 48, which is represented herein by a cylinder projecting from the corresponding rear face 23B and which is configured to control the eccentric rotational movements of the eccentric crank shaft 47. In other words, the servomotor 48 is configured to control the pressing actuator 46 so that the latter drives the slider 24 in an alternating translation movement along the vertical axis Z20, between the upper position thereof and the lower position thereof, at a frequency which is the frequency at which the press is triggered. In a simplified manner, the actuation device 28 works as a crankshaft the rotation of which is controlled by the servomotor, whereas the eccentric crank shaft 47 drives the slider 24 in a reciprocating motion between the upper and the lower positions thereof. Schematically, the pressing force is oriented along a pressing axis A49 which is an axis parallel to the height axis Z20 and which runs through the connection point 49 between the pressing actuator 46 and the slider 24. Advantageously, the pressing axis A49 is arranged so as to pass through, during the stamping step 220, the network of channels 104 formed on the strip. Preferably, the pressing axis A 49 is aligned with the center 105 of the network of channels 104. In the example illustrated, the stamping tool 42 is placed vertically below the pressing actuator 46, in particular vertically below the connection point 49 of the pressing actuator 46 with the slider 24.

According to examples, the stamping tool 42 is placed in the center of the working volume of the intermediate press 40. Thereby, any deformations of the frame 22 during the stamping step are distributed symmetrically about the pressing axis A49, which contributes to the homogeneity of the pressing force during the formation of the network of channels 104, and hence contributes to the quality of the stamping.

To this end, the intermediate press 40 advantageously comprises an odd number of pressing actuators 46. More particularly, the intermediate press 40 preferably comprises only one pressing actuator 46. When the intermediate press 40 comprises only one pressing actuator 46, the pressing actuator 46 is thereby arranged above the working zone, aligned with the middle of the working zone along the height axis Z20. When the intermediate press 40 comprises a plurality, e.g. three, of pressing actuators 46, the pressing actuators 46 are distributed along the shaft 47, one of the pressing actuators 46 being located substantially in the middle of the shaft 47 and being aligned with the middle of the working zone along the height axis Z20.

In general, in the presses of the prior art, the table has in the center thereof an opening, designed to discharge the material chips generated during the shaping operations. And yet the opening tends to reduce the stiffness of the table, which tends to bend during the operation of the press, the bending reducing the precision of the stamping operation.

Preferably, the table 26 of the intermediate press 40 is a so-called solid table, without a central chip discharge opening, e.g. provided in a block of solid metal. Of course, if need be, tapped holes or equivalent holes are provided in the table for fastening the shaping tools.

During the reciprocating movement of the slider 24 between the upper and the lower positions, the slider 24 reaches extreme positions, specifically reaches a lower position and a higher position. In the case of the stamping step 220, while the slider 24 moves from the upper position to the lower position, it will be understood that the strip 12, held between the two movable 43A and stationary 43B dies of the stamping tool 42, is clamped between the two dies 43A and 43B before the slider 24 reaches the lower position. As the slider 24 approaches the lower position, the clamping force of the dies 43A and 43B—and by extension the pressing force of the pressing actuator 46—progressively increases, plastically deforming the strip 12 so as to imprint the network of channels 104 in relief. The clamping force reaches a maximum when the slider 24 reaches the lower position thereof. The slider 24 then begins to rise. The strip 12, clamped between the two dies 43A and 43B, begins to relax elastically as the two dies 43A and 43B move away from each other. The clamping force gradually decreases, until canceling out. Thereby, the clamping force of the strip 12 by the stamping tool 42 is applied not only when the slider 24 is in the lower position, but for a range of positions around the lower position, which are called close to the lower position.

The movements of the slider 24 being controlled by the servomotor 48, it should be understood that the servomotor 48 is used to control in particular the speed of descent of the slider, the speed of rising of the slider, as well as the time interval during which the strip 12 is held clamped in the stamping tool 42 or else the clamping—or pressing—force undergone by the strip 12 during said time interval.

Preferably, during the stamping step 220, the pressing force is maintained, by the servomotor 48, for a predetermined time interval, and at a predetermined value, when the slider 24 is in the lower position or close to the lower position thereof, the secondary marking tool 224 being triggered during said time interval, so as to form the secondary reference mark 222 in the strip 12. The predetermined time interval during which the pressing force is maintained is called the “holding time”, while the predetermined value of the pressing force is called the “holding force”.

It is thereby ensured that the transient effects of stamping, in particular the vibrations of the intermediate press 40 and the elastic return of the strip 12, end before forming the secondary reference mark 222 on the strip 12. The secondary reference mark 222 is thereby placed more accurately on the strip 12.

The holding time is chosen to be greater than 0.2 s (second), preferably greater than 0.3 s, else preferably greater than 0.4 s, while the holding force is comprised between 150 kN (kilo Newton) and 300 kN, preferably between 170 and 250 kN, else preferably between 180 and 200 kN.

Advantageously, provision can be made to retract, during the holding time, the positioning members 38 which cooperate with the primary marking, in order to prevent an abnormal wear and pollutions generated by the deformation of the strip 12 during the stamping operation 220. The positioning members 38 can be reengaged after the holding time has expired, in particular for the end of the transfer of the strip 12 into the intermediate press 40.

According to embodiments, the servomotor 48 is slowed down while the slider 24 approaches the lower position thereof, so as to keep the stamping tool 42 clamped on the strip 12. Of course, the method of controlling the intermediate press 40 depends on the technology used for the press, and the specialist will be able to transpose the example described herein to presses of other technologies.

As a comparison, the pressing force required to draw the strip 12, in other words the stamping force, is on the order of 200 tons, or about 2000 kN. A good positioning of the secondary reference mark 222 is thereby provided, while avoiding excessive stress on the servomotor 48.

Once the secondary reference mark 222 is formed on the strip 12, the intermediate press 40 then returns to the higher configuration thereof, and the strip 12 is moved according to the feeding movement.

The forming method comprises a step 230 of cutting off the strip 12, which is subsequent to the stamping step 220 and during which the strip 12 is finally cut off, thereby forming the polar plate 100. Therefore, the cutting off is a shaping step, which is carried out herein by means of a cutting tool 232, which separates each elementary section 13 from the strip 12.

Where appropriate, the forming method comprises other shaping steps subsequent to the stamping step 220, e.g. pre-cutting steps, steps of reworking the perforations 106, etc. The shaping steps subsequent to the stamping step are called “downstream steps” of the forming method, the cutting step 230 being a particular example of a downstream step. Thereby the forming method comprises at least a downstream step.

The downstream step or steps are preferably carried out in the downstream press 60. Advantageously, during at least one downstream step, the strip 12 is positioned with respect to the downstream press 60 by means of positioning members 238 called secondary positioning members, which are mounted on the downstream press 60 and which cooperate with the secondary reference mark 222, in particular by mating shapes, so as to position the strip 12 with respect to the downstream press 60. The secondary positioning members 238 are represented herein by positioning fingers, which are received in the holes of the secondary reference mark.

Preferably, the secondary reference mark 222 is used to position the strip 12 during each of the downstream steps. As a corollary, only the stamping step 220 is carried out in the intermediate press 40, the stamping step 220 preferably including the forming of the secondary reference mark 222. In other words, the tool set of the intermediate press 40 includes, in addition to the stamping tool 42, the secondary marking tool 224.

According to a variant (not shown), the intermediate press 40 does not include any tool for shaping the strip 12 other than the stamping tool 42, without the secondary marking tool.

Generally, during the design of the forming plant 10, each press 20 is designed to exert a maximum pressing force, called nominal force, which is a function in particular of the maximum force needed for performing the task for which the press 20 is intended, and a safety factor.

In forming plants according to the prior art, the stamping press generally carries out other shaping steps, more particularly perforation and cutting operations. The presses of the prior art are thereby dimensioned to exert a nominal pressing force ranging from 800 to 1000 tons, or from 8 to 10 MN (Mega Newton).

In the forming plant 10, the downstream steps are carried out by the downstream press 60, whereas the steps prior to the stamping step 220, called upstream steps, are carried out by the upstream press 50.

More particularly, the primary marking step 200 is carried out by the upstream press 50, the primary marking tool 204 being mounted on the slider 24 of the upstream press 50. Similarly, in the example illustrated, the perforation step 210 is also carried out by the upstream press 50.

Thereby, in the forming plant 10, the pressing force of the downstream press 40 is used only at the stamping step 220. The intermediate press 40 is designed to generate a nominal pressing force of less than 4 MN, i.e. about 400 tons. Preferably, the nominal pressing force is less than 3 MN, else preferably less than 2 MN. The intermediate press 40 is much less expensive than a press used in a forming plant of the prior art.

The internal portion 16A refers to a portion of the strip 12 which is received in the working volume of a press 30, whereas a portion of the strip 12 located between two adjacent presses 30 is an external portion 16B of the strip 12. In FIG. 1, the strip 12 thus comprises three internal portions 16A and two external portions 16B. The forming plant 10 comprises tensioning members which are arranged between two adjacent presses 30 and which are configured to keep the inner portions 16A of the strip 12 taut, while keeping the outer portions 16B of the strip 12 released. The tensioning members are not shown. In practice, same can be gripper transfers, called “digital” transfers, moving along the axis X20 of the value of the elementary section 13 with a movement along the axis Z20 on the order of 5 mm.

According to examples, the tensioning members are combined with the feeding members.

Since the external portions 16B are released, the transmission of mechanical stresses along the strip 12 between two consecutive presses 30 is prevented. More particularly, since the stamping step 220 tends to “pull” on the strip 12, the released external portions 16B eliminate the risk of shifting the strip 12 with respect to the tools of the upstream and downstream steps.

The aforementioned embodiments and variants can be combined with each other so as to generate new embodiments of the invention.

1-11. (canceled)

12. A forming plant for polar plates for electrochemical cells of a fuel cell, wherein:
the forming plant is configured to form the polar plates in series from a metal strip, each polar plate being provided in an elementary section of the strip;
the forming plant comprises three distinct presses, each press comprising:
a movable slider arranged opposite a stationary table, the slider being moved by an actuation device between an upper position and a lower position, the slider and the table together delimiting a working volume of the press; and
a tool set for forming the strip, each tool set comprising at least one tool with a movable portion, which is carried by the corresponding slider and which delimits a working zone of the corresponding press;
each press is configured to let through the strip in the corresponding working volume and includes a feeding device for moving the strip, wherein the feeding device is configured to control a feeding movement of the strip along the table, the feeding movement being a sequential movement, with an increment of the feeding equal to a length of each elementary section measured along the strip, and a predetermined feeding frequency, the feeding movement defining a downstream direction of each press, each press being configured to move the corresponding slider to a lowered position after each feeding movement;
the distinct presses are the following:
an upstream press, the tool set of which includes a primary marking tool, which is configured to form a primary reference mark in the strip when the corresponding slider moves from the upper position thereof to the lower position thereof;
an intermediate press, the tool set of which includes a stamping tool, which is fastened to the corresponding slider and which is configured to stamp a network of channels for the circulation of fluids in relief on the strip, when the corresponding slider moves from the upper position thereof to the lower position thereof; and
a downstream press, the tool set of which includes a cutting tool configured to separate each elementary section from the rest of the strip when the corresponding slider moves from upper position thereof to the lower position thereof;
the intermediate press is arranged, in the feeding direction, downstream of the upstream press, whereas the downstream press is arranged downstream of the intermediate press, in such a way that, under established operation of the forming plant, the strip runs continuously through the three presses, each portion of the strip received in the working volume of one press being an internal portion of the strip, whereas each portion of the strip situated between two adjacent presses is an external portion of the strip;
the forming plant comprises tensioning members, which are arranged between two adjacent presses and which are configured to keep the inner portions of the strip tensioned, while keeping released the outer portions of the strip;
the actuation device of the intermediate press comprises a pressing actuator, which is connected to the slider by a connection point and which moves the slider between the upper and lower positions thereof and which is configured to exert a pressing force on the slider when the corresponding slider is in the lower position thereof and the strip is stamped by the stamping tool; and
the pressing force is oriented along a pressing axis, which runs through the connection point and which runs through the network of channels.

13. The forming plant of claim 12, wherein the stamping tool is configured to stamp the network of channels of only one elementary section on the strip, after each feeding movement.

14. The forming plant of claim 12, wherein the tool set of the intermediate press includes no strip forming tool other than the stamping tool.

15. The forming plant of claim 12, wherein the tool set of the intermediate press includes, in addition to the stamping tool, a secondary marking tool configured to form a secondary reference mark in the strip while the strip is held clamped in the stamping tool.

16. The forming plant of claim 15, wherein the secondary marking tool is configured to form the secondary reference mark in the strip when the slider of the intermediate press is in the lower position or close to the lower position thereof.

17. The forming plant of claim 15, wherein the feeding device of the downstream press comprises positioning members which are configured to cooperate with the secondary reference mark provided in the strip, so as to position the strip.

18. The forming plant of claim 15, wherein the actuation device of the intermediate press comprises a servomotor, which controls the pressing actuator and which is configured to maintain a pressing force for a predetermined time when the slider is in the lower position, wherein the secondary marking tool comprises another actuation device, which is carried by the slider and which is triggered while the strip is held clamped in the stamping tool, so as to form the secondary reference mark in the strip.

19. The forming plant of claim 12, wherein the actuation device of the intermediate press comprises only one pressing actuator.

20. The forming plant of claim 12, wherein the actuator of the intermediate press is configured to generate a nominal pressing force of less than 4 Mega Newtons.

21. The forming plant of claim 12, wherein the table of the intermediate press is a solid table.

22. A method of forming a polar plate, the forming method being implemented by means of a forming plant of claim 15, the forming method comprising the steps of:
a) while an inner portion of the strip is received in the working volume of the intermediate press, moving the slider from upper position thereof to the lower position thereof, and stamping on the strip the relief of the network of channels for the circulation of fluids; and
b) while the strip is held tightly in the stamping tool, using the secondary marking tool and forming the secondary mark on the strip.
